(19) United States
(12) Patent Application Publication
(10) Pub. No.: US 2002/0155232 A1
(43) Pub. Date: Oct. 24, 2002

(54) Multilayer composite pressure vessel

(76) Inventor: Thomas K. DeLay, Huntsville, AL (US)

Correspondence Address: James J. McGroary, NASA/Marshall Space Flight Center, LS01/ Office of Chief Counsel, Huntsville, AL, 35812, US

(21) Appl. No.: 09/917,846

(22) Filed: Jul. 26, 2001

Related U.S. Application Data
(60) Provisional application No. 60/285,913, filed on Apr. 24, 2001.

(51) Int. Cl. B32B 1/02

(52) U.S. Cl. 428/34.1; 428/36.3; 156/187

(57) ABSTRACT

Two problems face fabricators of pressure tanks for space flight use. First, helium is the most common pressurant gas for launch vehicles, yet composite tanks, and liners used in other tanks carrying helium perform poorly. Pressure tanks fabricated using steel, aluminum, and copper are too heavy for space flight use. Second, cost is a considerable factor when tanks must be configured to fit in spaces of various sizes and shapes available for them. By the method herein pressure tanks having very low permeabilities for gases can be fabricated in various sizes and shapes. A mandrel is cut out of foamed plastic. It is then wrapped or overlayed with composite materials in three stages to form the pressure tank.

### CROSS-REFERENCE TO A RELATED APPLICATION

My application entitled Method of Making a Composite Tank has now issued as U.S. Pat. No. 6,193,917. The patent discloses a method for making a composite tank for liquid oxygen, and the use of a water-soluble mandrel. A provisional application 60/285,913 was filed on Apr. 24, 2001.

### STATEMENT REGARDING FEDERALLY-SPONSOR RESEARCH OR DEVELOPMENT

The invention described in this patent was made by an employee of the United States Government and may be manufactured and used by or for the Government for governmental purposes without the payment of any royalties.

### BACKGROUND OF THE INVENTION

1. Field of the Invention

This invention, in one of its embodiments, provides a method for inexpensively producing composite pressure tanks having very low permeabilities for gases, for instance, tanks for upper stage spacecraft, and containers or other vessels for liquid helium and the like. Helium is the most common pressurant gas for launch vehicles. Non-metallic materials and liners used in tanks carrying helium perform poorly, indicating a need for tanks which confine gases such as helium with very little leakage. In another of its embodiments the invention affords a means for producing composite pressure vessels in many sizes and shapes without tooling costs normally associated with traditional composite tank manufacturing. There is a need, then, for non-standard sized containers for pressurized gases.

2. Background Information

The cost of a pressure tank is a function of its volume and of tooling costs. And a major portion of the tooling costs is attributable to the fabrication of a mandrel. The importance of the mandrel can readily be discerned by examining the patent art. The use of mandrels is disclosed in U.S. Pat. Nos. 6,190,598, 6,095,367 and 5,822,838. In other patents, for instance, U.S. Pat. Nos. 6,190,481, and 4,584,041, inner liners serve as mandrels. In that case costs are associated with molding means utilized to form the liners. In other patents less important means are used which have not found a niche in production, such as the inflatable mandrel in U.S. Pat. No. 6,176,386, and water soluble mandrels such as U.S. Pat. No. 5,653,358 and applicant's related patent mentioned hereinbefore. In U.S. Pat. No. 6,145,692 a liner is fabricated using steel, aluminum, copper, nickel, or tungsten by means not disclosed. Such pressure tanks are too heavy for space flight use.

The patent art, then, illustrates, that from a commercial point of view, either a mandrel is employed, or other equally costly molding equipment such as vacuum molding, pressure molding, or blow molding. Even then the pressure vessels are subject to certain disadvantages. Unsettled in the space program is whether one large pressurant tank is preferable to several smaller tanks for upper stages. The costs of tooling for large pressure tanks, say forty to seventy inches in diameter, is prohibitive at over a quarter of a million dollars. Making several tanks of different sizes, by the same token, entails tooling costs for different sized mandrels. The same cost considerations come into play when tanks must be configured to fit in variously shaped spaces. As an example, there is a demand for tanks that are shaped to conform to the shapes of spaces available for them. And, as a way of saving space, upper-stage launch vehicles and automobiles sometimes require fuel tanks that are not cylindrical. However, the fabrication of such tanks is not presently cost effective.

An object of this invention is the provision of a cost effective method for readily fabricating pressure tanks in various sizes and shapes. Another object of the invention is to provide a mandrel which does not impact total costs. Still another object of the invention is the provision of a unique method for fabricating mandrels for pressure tank manufacture.

### SUMMARY OF THE INVENTION

This invention is directed to solutions to the expensive tooling and variable tank size problems that have limited the use of composite pressure tanks in high end applications such as rocket upper stages. There are two aspects to this solution.

First, the costs of tooling for machining metal mandrels, and of making molds for molding mandrels have been greatly reduced by the process herein. A mandrel is made by turning or otherwise carving a soft but rigid material into a mandrel having the desired shape.

Second, the mandrel is wrapped or overlayed in three stages. With appropriate tank fittings attached, the mandrel is wrapped, along with a portion of the fittings, with a fiber reinforced resin which, when cured forms an inner composite layer. After the mandrel is removed, a thin low gas permeability barrier film is applied as an intermediate layer. This intermediate barrier layer is then overlayed with an outer composite layer for added strength. The invention, then, provides a process for making light weight pressure tanks in various sizes and shapes for the storage of gases which require low permeability tank walls. By one embodiment of this invention a pressure tank can even be fabricated which retains helium.

### DESCRIPTION OF THE INVENTION

For a better understanding of the pressure tank fabrication method of the invention, and of the characteristics of pressure tanks made by the process, the techniques will now be described in conjunction with the following drawings.

### BRIEF DESCRIPTION OF THE DRAWINGS

FIG. 1 is an isometric view showing the fabrication of a mandrel.

FIG. 2 is an isometric view showing the mandrel of FIG. 1 with a recess for one of the tank fittings.

FIG. 3 is an enlarged cross sectional view of a tank fitting.

FIG. 4 is a cross sectional view showing a portion of the mandrel with a composite layer covering it and part of a tank fitting as an inner composite layer.

FIG. 5 is an isometric view showing the opening of the inner composite layer in order to remove the mandrel.

FIG. 6 is an isometric view showing the repaired inner composite layer following the removal of the mandrel.

FIG. 7 is a cross sectional view showing a portion the inner composite layer with a barrier layer deposited thereon.

FIG. 8 is a cross sectional view showing a portion of the structure of FIG. 7 with the outer composite layer applied thereto.

FIG. 9 is an isometric view of a finished tank.

### DESCRIPTION OF PREFERRED EMBODIMENTS

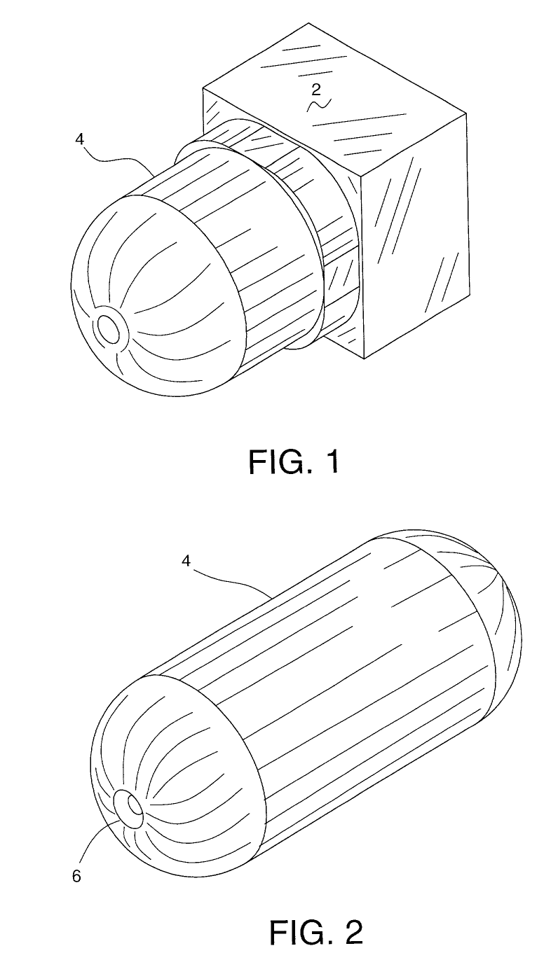

One of the features of this invention is the provision of a cost-saving mandrel. Rather than a machined or molded metal mandrel, a mandrel is fabricated, in our preferred embodiment, from a block of foamed plastic. Because of its ready availability a foamed resin is preferred over other softer materials. Hence its use will be described herein. In FIG. 1 the carving of a mandrel is illustrated. The figure shows a portion of the block 2 and a portion of the mandrel 4 are illustrated. Rigid foams are readily available, examples being polyester and polyether foams, PVC foams, silicone foams, foamed polystryene, and the like, with polyurethane foams being preferred herein.

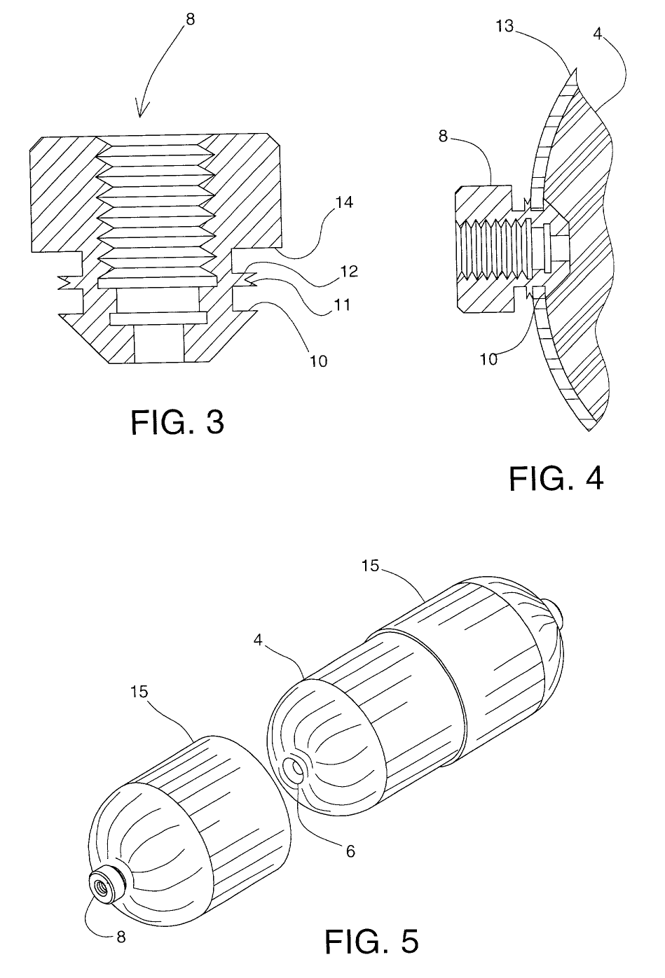

By turning on a lathe or by other carving means the mandrel can be shaped into its desired configuration. Such a finished mandrel 4 is illustrated in FIG. 2 along with recess 6 provided for a tank fitting. The tank produced must have one or more fittings for attachment of gas lines and other essential devices. A cross section of such a tank fitting 8 is shown in FIG. 3. In order to conveniently wrap the fitting, as will be described, it is best inserted in a recess such as recess 6. In order to anchor tank fitting 8 so that it becomes an integral part of the finally produced tank it is provided with a flange 10 for an inner composite layer, a notch 11 for a barrier layer, a flange 12 for an outer composite layer, and a shoulder 14 for stability, all of which can be seen in FIG. 3.

FIG. 4 shows a portion of mandrel 4 with its first, or inner, composite layer 13 enveloping it. It is noted that as mandrel 4 is wrapped the fiber reinforced resinous layer 13 overlaps flange 10 (FIG. 3) to bond fitting 8 to composite layer 13. To envelop mandrel 4 with the fiber reinforced resin any of the known layup methods can be used, along with various pressures, for instance hand layup, filament winding, and vacuum bag or press molding. Equally well known are the composite materials, that is, fiber materials and the resins used to impregnate the fiber materials to form the composite. Desirable fibers are continuous filament materials, for example carbonaceous fibers, organic fibers, inorganic fibers, ceramic fibers, and “Kevlar” (a trademark for an aromatic polyamide fiber), our preferred fibers being graphite fibers.

A wide variety of resins, both thermoplastic and thermosetting, have also been used in composites. Examples are thermosetting polyesters, polyimides, polyurethanes, silicones, bis-maleimide resins, and urea or melamine aldehyde resins (amino resins). Thermoplastic resins such as polyetherketone and polyphenylene sulfide are not as widely used. Our preferred resin is a heat curable epoxide resin where tape layup is used, although an epoxide resin with a curing agent affording a long enough curing period for hand layup can be used.

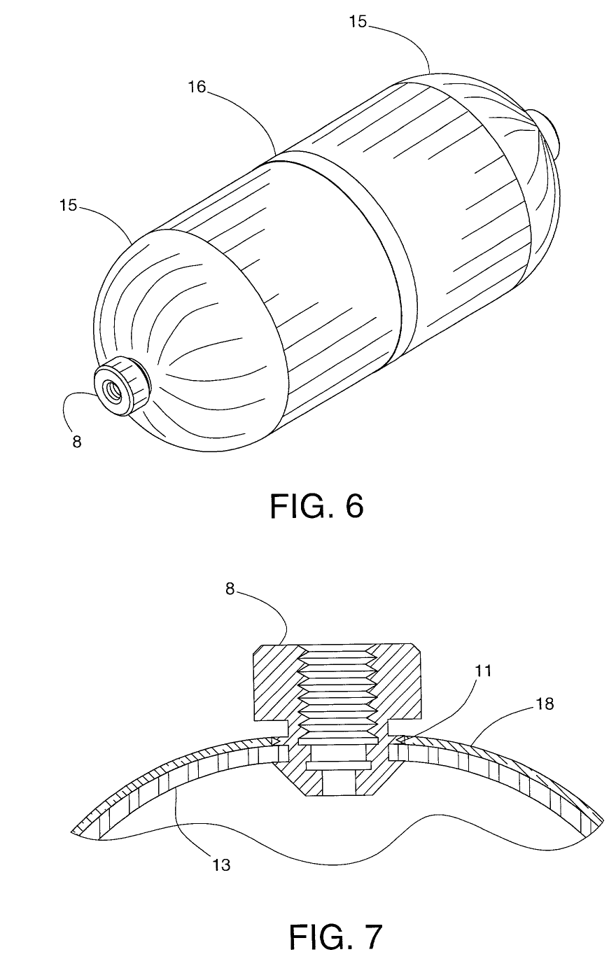

In the process herein a composite material will be applied to a mandrel and the composite material will be heated to cure the resin to form a composite layer. After the composite layer 13 is formed it is cut in half so that mandrel 4 can be removed. A mold release can, of course, be employed, depending upon the mandrel material and the resin selected. Shown in FIG. 5 are the two halves 15 and mandrel 4. Following removal of the mandrel, the two halves 15 can be patched to form a composite layer 13 by the use of any number of methods, one being the application and curing of composite band 16 illustrated in FIG. 6. The resulting structure shown in the figure is now, in effect, a tank. However, in this instance it will become the inner layer (13) of the ultimate composite pressure tank.

As previously indicated, many gases require tank liner materials with very low permeability. Another feature of this invention is the provision of such a liner in the form of a gas permeation barrier layer. As illustrated in FIG. 7 this barrier layer, or liner, 18 is disposed over the surface of inner layer 13 and in notch 11 in the tank fitting. It has been found that films of rubber, copper or nickel form low permeability layers. Again methods are known for applying films of such materials. As examples composite layer 13 can be coated with natural or synthetic latex which can then be vulcanized. To deposit films of metals electroforming techniques are available, and these gas permeation barrier films can be as thin as 0.005 inches, with thicker films merely adding to the cost. It is pointed out at this juncture that, because of its small molecular structure, if helium is to be stored copper or nickel should be used in the fabrication of the barrier layer. For gases such as methane and propane having larger molecules the rubber barrier layer is effective.

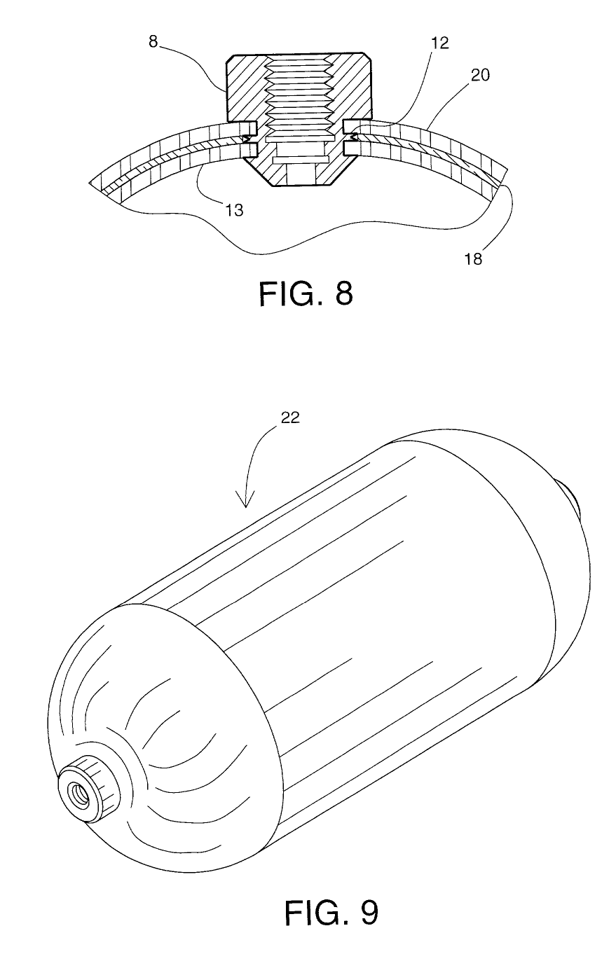

Referring now to FIG. 8, following the formation of barrier layer 18, an additional composite layer 20 is applied over the gas permeation barrier as a pressure tank outer layer. The materials for composite layer 20 will be fiber reinforced resins such as those discussed in connection with inner composite layer 13, in other words, the carbonaceous, organic, inorganic, and ceramic fibers, and both thermoplastic and thermosetting resins.

With the curing of composite layer 20 the final multilayer composite pressure vessel will have been fabricated having inner composite layer 13, low permeability barrier layer 18, and outer composite layer 20 (FIG. 8. The finished composite pressure vessel is shown in FIG. 9. It will be appreciated that the outer surface of composite layer 20 can be finished, coated, or otherwise treated for the sake of appearance. The multilayer composite pressure tank provided herein will be particularly useful in aerospace areas wherein there are frequent design and size changes, and wherein both large and small multilayer composite pressure tanks are required. In fact it has been found that larger than normally feasible composite tanks can be fabricated by the invention. In addition, a tank can be made which is superior to those fabricated heretofore. For instance, if the material stored has a tendency to corrode the barrier layer it will have been protected by the inner composite layer.

Thus, by the provision of a method by which larger and non-standard sized composite pressure tanks can be fabricated this invention fills a void in multilayer composite pressure tank production. In addition, the use of a foamed mandrel offers an economical approach unique to the industry.

Having been given the teachings of this invention variations and ramifications will occur to those in the art. As an example instead of foamed plastic mandrel blocks soft wood such as balsam, can be employed, as well as pressed wood, compressed or treated paper pulp and cardboard. As another variation prepreg strips or tapes can be utilized in the formation of the two composite layers, or the mandrel can be wrapped with larger pieces of fiber material and then impregnated with the resin with or without a cross-linking agent, depending upon whether the composition is heat curable. As still another variation, instead of cutting the mandrel from a large block of foamed material, a series of small foamed blocks can be bonded together. In addition, the inner composite layer (13) containing the foamed mandrel need not be cut in half, but it can be separated in any number of ways, depending upon whether the mandrel is to be reused. Indeed, with the proper selection of resins and foaming polymer it will is also be possible to bum out the foamed mandrel and skip the patching operation. It is also possible to eliminate the formation of the recess and apply fittings 8 to the outside of inner layer 13. These and other modifications which will occur to those skilled in the art are deemed to be within the scope of this invention.

What is claimed is:

1. A method for producing composite pressure tanks having very low permeabilities for gases, comprising
a. machining a rigid but soft material into a mandrel having a desired tank configuration;
b. in one end of the mandrel cutting a recess sized to slidably receive a tank end fitting;
c. inserting in the recess a flanged tank end fitting;
d. wrapping the mandrel and the tank end fitting flange with a composite material;
e. curing the composite material with the mandrel therein to form a composite structure having a tank end fitting;
f. opening the structure and removing the mandrel;
g. resealing the opening with a fiber reinforced polymeric material;
h. curing the reinforced polymeric sealing material to reform the composite structure;
i. covering the composite structure with a film-formed gas permeation barrier layer;
j. overlaying the gas permeation barrier layer with an outer composite overwrap; and
k. curing the outer overwrap to produce the composite pressure tank.

2. The method of claim 1 wherein the rigid but soft material is a polymeric foamed plastic and the composite material and the composite overwrap are fiber reinforced resins.

3. The method of claim 2 wherein the foamed plastic is polyurethane foam and the composite material and the composite overwrap are epoxide resins reinforced with graphite fibers.

4. The method of claim 2 wherein the rigid polymeric foam is foamed polystyrene and the composite material and the composite overwrap are polyimide resins reinforced with aromatic polyamide fibers.

5. The method of claim 2 wherein film-forming gas permeation barrier layer is rubber.

6. The method of claim 2 wherein film-forming gas permeation barrier layer is a layer of copper electrodeposited over the composite structure.

7. The method of claim 2 wherein film-forming gas permeation barrier layer is a layer of nickel electrodeposited over the composite structure.

8. A composite pressure tank formed with (a) an inner wall made of fiber reinforced composite material, (b) a thin intermediate low gas permeability barrier layer selected from the group of rubber, copper, and nickel, and (c) an outer fiber reinforced composite layer conferring additional strength on the tank.

9. A composite pressure tank for helium formed with (a) an inner wall made of fiber reinforced composite material, (b) a thin intermediate low gas permeability barrier layer selected from the group of copper, and nickel, and (c) an outer fiber reinforced composite layer conferring additional strength on the tank.
